(19) United States
(12) Patent Application Publication
(10) Pub. No.: US 2025/0389306 A1
(43) Pub. Date: Dec. 25, 2025

(54) DRUM BRAKE

(71) Applicants: HYUNDAI MOTOR COMPANY, SEOUL (KR); KIA CORPORATION, SEOUL (KR)

(72) Inventors: Jung Ro Yoon, Hwaseong-si (KR); Sung Hyun Cho, Hwaseong-si (KR); Jeong Kyu Kim, Hwaseong-si (KR)

(73) Assignees: HYUNDAI MOTOR COMPANY, SEOUL (KR); KIA CORPORATION, SEOUL (KR)

(21) Appl. No.: 18/947,669

(22) Filed: Nov. 14, 2024

(30) Foreign Application Priority Data
Jun. 20, 2024 (KR) 10-2024-0080418

(51) Int. Cl. F16D 65/08; F16D 65/00

(52) U.S. Cl. CPC F16D 65/08; F16D 65/0006

(57) ABSTRACT

A drum brake includes a brake shoe provided inside a drum and operating toward the drum by a pressing member that operates a piston in one direction, a lining coupled to the brake shoe to apply a braking force to the drum, a rim to which the lining is attached and of which one side is machined into a curved surface corresponding to a predetermined function, and a brake noise preventing member that is coupled to the one side of the rim and decreases squeal noise generated at a time point at which the braking force is generated by the lining and the drum.

### CROSS REFERENCE TO RELATED APPLICATIONS

This application claims the benefit of priority to Korean Patent Application No. 10-2024-0080418, filed in the Korean Intellectual Property Office on Jun. 20, 2024, the entire contents of which are incorporated herein by reference.

### TECHNICAL FIELD

The present disclosure relates to a drum brake, and more particularly, to a technology for suppressing a reflected wave of a drum brake.

### BACKGROUND

A braking device for a vehicle is a device that performs a braking operation by converting rotational kinetic energy of wheels into thermal energy through a drum brake. Therefore, resonance occurs in the braking device due to exciting energy of the drum brake, and when the resonance exceeds a damping limit of a system, noise may occur.

Here, when the noise corresponds to a frequency range of 1 kHz to 16 kHz, the noise is a squeal noise, an unpleasant sound, which is a major complaint of users. However, even when the squeal noise of the braking device is designed to be prevented during a mobility development operation, a lining of the drum brake included in the braking device wears out over time, vibration characteristics of the braking device is also changed, and thus noise that has not occurred in the development operation may occur at a later time.

To solve this problem, it is required to develop a technology of suppressing reflected waves generated during braking as a curved surface is formed on a rim of the drum brake and reducing braking friction noise as a brake noise preventing member is coupled to one side of the rim.

### SUMMARY

The present disclosure has been made to solve the above-mentioned problems occurring in the prior art while advantages achieved by the prior art are maintained intact.

An aspect of the present disclosure provides a drum brake that decreases development costs of the drum brake due to frequency avoidance between components included in the drum brake and addition of a damping member for an amplitude decrease to the drum brake.

Another aspect of the present disclosure provides a drum brake including a rim machined into a curved line based on a first function for suppressing reflected waves of a brake and a second function for cooling the brake, thereby suppressing squeal noise and the reflected waves of the brake.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a drum brake includes a brake shoe provided inside a drum and operating toward the drum by a pressing member that operates a piston in one direction, a lining coupled to the brake shoe to apply a braking force to the drum, a rim to which the lining is attached and of which one side is machined into a curved surface corresponding to a predetermined function, and a brake noise preventing member that is coupled to the one side of the rim and decreases squeal noise generated at a time point at which the braking force is generated by the lining and the drum.

In an embodiment, the brake noise preventing member may include at least one of a viscoelastic layer made of rubber, or a viscoelastic layer made of polyurethane, or any combination thereof.

In an embodiment, the viscoelastic layer made of rubber may include a layer including an adhesive, rubber, and metal.

In an embodiment, the viscoelastic layer made of polyurethane may include a layer including an adhesive, polyurethane, and nanoclay.

In an embodiment, the rim may be machined into a curved surface corresponding to at least one of a first curved line corresponding to the predetermined function, a second curved line different from the first curved line, or a linear line, or any combination thereof.

In an embodiment, the first curved line may be determined based on a first function for suppressing reflected waves in the drum brake.

In an embodiment, the second curved line may be determined based on a second function for cooling the drum brake.

In an embodiment, the rim may include one surface attached to the lining, and the other surface formed to be opposite to the one surface and facing a web connected to the pressing member, and at least a partial area of the other surface may be spaced apart from the web.

In an embodiment, the other side of the rim, which is different from the one side thereof, may be machined into a curved surface corresponding to the predetermined function.

Additional features and advantages are described herein, and will be apparent from, the following Detailed Description and the figures.

### BRIEF DESCRIPTION OF THE FIGURES

The above and other objects, features and advantages of the present disclosure will be more apparent from the following detailed description taken in conjunction with the accompanying drawings:

FIG. 1 is a plan view illustrating a drum brake according to an embodiment of the present disclosure;

FIG. 2 is an enlarged view illustrating the drum brake according to an embodiment of the present disclosure;

FIG. 3 is a view for describing a position in which a brake noise preventing member is mounted in the drum brake according to an embodiment of the present disclosure; and

FIG. 4 is a view for describing a curved surface included in a rim in the drum brake according to an embodiment of the present disclosure.

In connection with the description of the drawings, the same or similar components may be designated by the same or similar reference numerals.

### DETAILED DESCRIPTION

Hereinafter, some embodiments of the present disclosure will be described in detail with reference to the exemplary drawings. In adding reference numerals to components of each drawing, it should be noted that identical or equivalent components are designated by an identical numeral even when they are displayed on other drawings. Further, in describing an embodiment of the present disclosure, a detailed description of the related known configuration or function will be omitted when it is determined that the detailed description interferes with the understanding of an embodiment of the present disclosure. In particular, various embodiments of the present disclosure will be described with reference to the accompanying drawings. Accordingly, those of ordinary skill in the art will recognize that modification, equivalent, and/or alternative on the various embodiments described herein may be variously made without departing from the scope and spirit of the disclosure. With regard to the description of drawings, similar components may be denoted by similar reference numerals.

Further, in describing the components of embodiments of the present disclosure, terms, such as first, second, “A”, “B”, (a), and (b) may be used. These terms are merely intended to distinguish one component from other components, and the terms do not limit the nature, order, or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. For example, expressions, such as “a first,” “a second,” “the first,” or “the second,” used in the present disclosure refer to various components regardless of order and/or importance, and may be only used to distinguish one component from another component and does not limit the components. For example, a first user device and a second user device may refer to different user devices regardless of sequence or importance. For example, a first component may be renamed a second component without departing from the scope of rights described in the present disclosure, and similarly, a second component may also be renamed a first component.

In the present disclosure, expressions, such as “have,” “may have,” “includes,” or “may include” indicate the presence of the corresponding feature (e.g., a numerical value, a function, an operation, or a component such as a part), and does not rule out the presence of additional features.

When it is mentioned that a component (e.g., a first component) is “(functionally or communicatively) coupled with/to” or “connected” to another component (e.g., a second component), it should be understood that the certain component may be connected directly to the other component or may be connected through another component (e.g., a third component). On the other hand, when it is mentioned that a component (e.g., a first component) is “directly connected” or “directly electrically connected” to another component (e.g., a second component), it may be understood that there is no component (e.g., a third component) between the component and the other component.

The expression “configured to” used in the present disclosure may be used as, depending on the context, for example, “suitable for,” “having the capacity to”, “designed to,” “adapted to,” “made to,” or “capable of.”

The term “configured (or set to)” may not necessarily mean “specifically designed to” in hardware. Instead, in some situations, the expression “device configured to” may mean that the device is “capable of” working with other devices or components. For example, the phrase “processor configured (or set) to perform A, B, and C” may refer to a processor dedicated to performing the operations (e.g., an embedded processor) or a general-purpose processor (e.g., a CPU or an application processor) capable of performing the corresponding operations by executing one or more software programs stored on a memory device. Terms used herein are merely used to describe specific embodiments and may not be intended to limit the scope of other embodiments. Singular expressions may include plural expressions unless clearly otherwise indicated in the context. Terms used herein including technical or scientific terms have the same meanings as those commonly understood by those skilled in the art disclosed in the present document. Terms defined in a general dictionary among the terms used herein may be interpreted as the same or similar meanings as the meanings in the context of the related art and are not interpreted as ideal or excessively formal meanings unless explicitly defined herein. In some cases, even terms defined herein may not be interpreted to exclude embodiments of the present document.

In the present disclosure, expressions, such as “A or B,” “at least one of A or/and B,” or “one or more of A or/and B”, may include all possible combinations of the items listed together. For example, “A or B,” “at least one of A and B,” or “at least one of A or B” (1) may include at least one A, (2) may include at least one B, or (3) may refer to all cases including both at least one A and at least one B. Additionally, in describing the components of embodiments of the present disclosure, the phrase, such as “A or B”, “at least one of A and B”, “at least one of A or B”, “A, B or C”, “A, B, and C,” “at least one of A, B, or C,” and “at least one of A, B, C, or any combination thereof,” may include any one of the items listed together, or any possible combination of them. In particular, phrases, such as “at least one of A, B, or C, or any combination thereof”, may include A or B or C or a combination thereof such as AB or ABC.

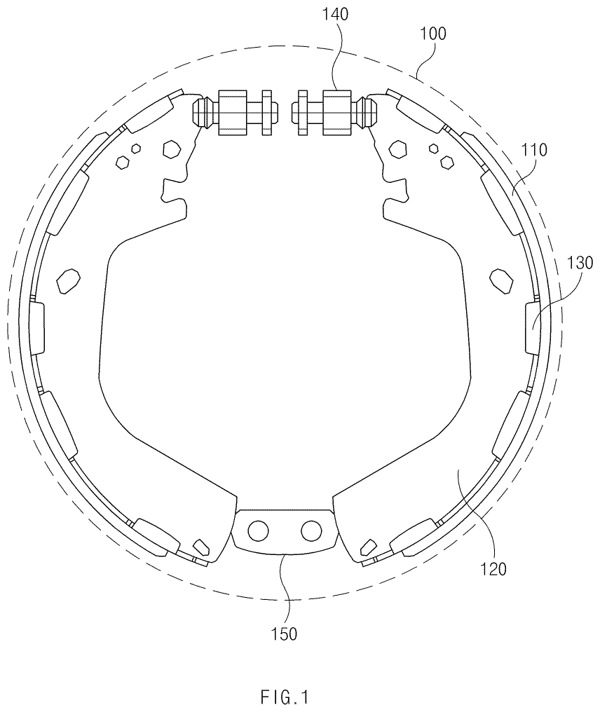

Hereinafter, embodiments of the present disclosure will be described in detail with reference to FIGS. 1 to 4.

FIG. 1 is a plan view illustrating a drum brake according to an embodiment of the present disclosure.

A drum brake 100 according to an embodiment may include a lining 110, a web 120, a rim 130, a wheel cylinder 140, an anchor plate 150, and a drum. For example, a brake shoe of the drum brake 100 may include the lining 110, the web 120, and the rim 130. The drum brake 100 may decrease braking friction noise through a reflected wave suppressing member of the shoe.

In detail, a vehicle equipped with the drum brake 100 may be braked by friction between the lining 110 of the brake shoe and the drum when a driver steps on a brake pedal. In this case, the braking friction noise may be generated due to the friction between the lining 110 and the drum. The braking friction noise may be generated as waves are propagated in a circumferential direction of the brake shoe due to the friction between the lining 110 and the drum and the propagated waves serve as an excitation source. Here, the drum brake 100 may delay and dissipate the propagation of waves that may be generated by applying a reflected wave suppressing member to a distal end of the rim 130 in the brake shoe. The drum brake 100 may finally decrease the braking friction noise through a decrease in an excitation force of the excitation source.

The brake shoe may be provided inside the drum brake 100, may be mounted on the anchor plate 150, and may operate toward a drum by a piston of the wheel cylinder 140 that operates a piston inserted thereinto in one direction. The piston of the wheel cylinder 140 may translate the brake shoe in a drum direction through a hydraulic pressure.

The lining 110 may be coupled to the brake shoe to apply a braking force to the drum.

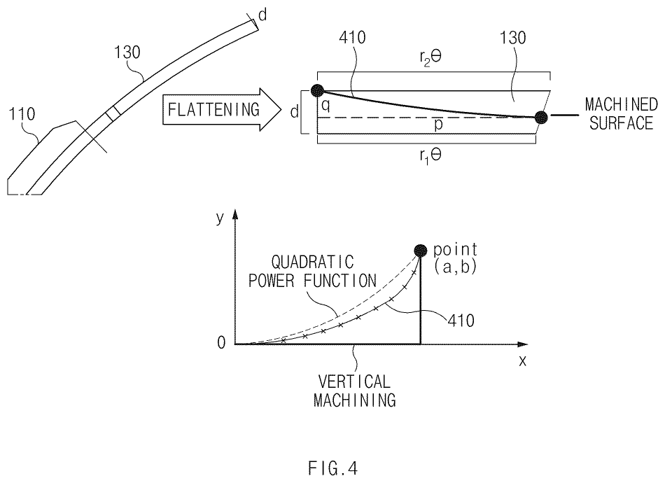

The web 120 and the lining 110 connected to the wheel cylinder 140 may be attached to the rim 130, and one side of the rim 130 may be machined into a curved surface corresponding to a predetermined function. For example, the one side of the rim 130 may include the curved surface corresponding to the predetermined function and may be coupled to a brake noise preventing member. A detailed description of the predetermined function will be made below in FIG. 4.

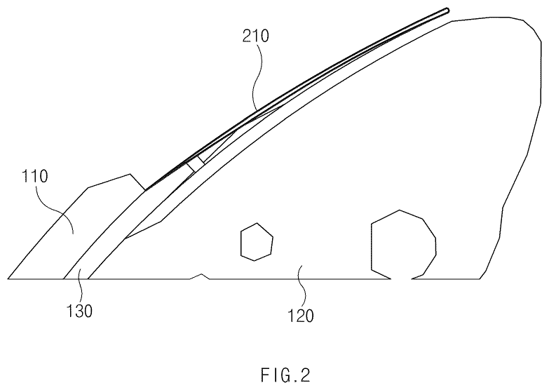

The brake noise preventing member may be coupled to the one side of the rim 130. For example, the brake noise preventing member may refer to a member that decreases squeal noise generated at a time point at which the braking force is generated by the lining 110 and the drum. A detailed description of the brake noise preventing member will be described below in FIG. 2.

The drum brake 100 may achieve resonance avoidance design through frequency mode separation between components. The drum brake 100 may improve surface pressure distribution by adjusting a bonding angle of the lining 110. The drum brake 100 may improve the surface pressure distribution by improving a contact angle with the anchor plate 150 positioned at a lower end of the brake shoe. In the drum brake 100, the brake noise preventing member may be added in both directions (i.e., one side direction of the rim 130) of a circumference, in which waves are generated, to decrease a vibration amplitude of the excitation source itself, and thus solid waves generated by friction may be effectively trapped. Additionally, the drum brake 100 may dissipate waves through a viscoelastic layer of the brake noise preventing member. The drum brake 100 may decrease a mass of a braking device through the curved surface included in the one side of the rim 130 and corresponding to the predetermined function.

FIG. 2 is an enlarged view illustrating the drum brake according to an embodiment of the present disclosure;

Referring to FIG. 2, the drum brake 100 may include a brake noise preventing member 210 that is coupled to the one side of the rim 130 and decreases the squeal noise generated at a time point at which the braking force is generated by the lining 110 and the drum. However, a position of the brake noise preventing member 210 is not limited thereto. For example, the rim 130 may be machined into the curved surface corresponding to the predetermined function on the other side (e.g., a side portion of the rim 130 adjacent to the anchor plate 150) that is different from one side (e.g., a side portion of the rim 130 adjacent to the wheel cylinder 140). However, the present disclosure is not limited thereto, and the other side of the rim 130 may be machined into a curved surface that is different from the curved surface machined into the one side.

The rim 130 may include one surface attached to the lining 110 and the other surface opposite to the one surface and facing the web 120. For example, the one surface may refer to a surface of the rim 130 adjacent to the lining 110, and the other surface may refer to a surface of the rim 130 adjacent to the web 120. At least a portion of the other surface of the rim 130 may be spaced apart from the web 120.

The effects obtained by spacing the at least a portion of the other surface of the rim 130 apart from the web 120 are as follows. For example, to maximize an effect of the brake noise preventing member 210 that is a reflected wave suppressing device, coupling between the rim 130 of the drum brake 100 and other components should be decreased as much as possible. At an end of design of the brake shoe, when the rim 130 and the web 120 are coupled to each other, the rim 130 and the web 120 may be separated from each other within a range in which design rigidity and strength may be secured. Therefore, the brake noise preventing member 210, which is a viscoelastic layer, may be attached to an upper end (i.e., an upper end of the rim 130) of a machined surface of a power function, thereby dissipating the trapped waves.

The brake noise preventing member 210 may include at least one of a viscoelastic layer made of rubber, or a viscoelastic layer made of polyurethane, or any combination thereof. In detail, the viscoelastic layer made of rubber may include a layer including an adhesive, rubber, and metal. The viscoelastic layer made of polyurethane may include a layer including an adhesive, polyurethane, and nanoclay.

Illustratively, the viscoelastic material may refer to a material that has both viscous properties and elastic properties. An elastic material may move along a linear line in which a stress-strain behavior of an object during a tension/compression process and a process of restoration to an original state is always constant. The viscoelastic material may follow different stress-strain curves when tensioned or compressed or restored to an original state, and may dissipate energy by an area corresponding to a difference between the stress-strain curves. The brake noise preventing member 210 may mainly include four layers such as an adhesive-rubber-metal-rubber adhesive and may have viscoelastic properties due to the rubber and the adhesive. That is, the brake noise preventing member 210 may include a member including the viscoelastic layer as a material and a member including a viscoelastic layer composite composition as a material. The member including the viscoelastic layer as a material may include a viscoelastic layer including rubber as a material and a viscoelastic layer including a polymer resin as a material. The member including a viscoelastic layer composite composition may include a viscoelastic layer including an adhesive-rubber-metal layer and a viscoelastic layer including an adhesive-polyurethane (polymer resin)-nanoclay layer.

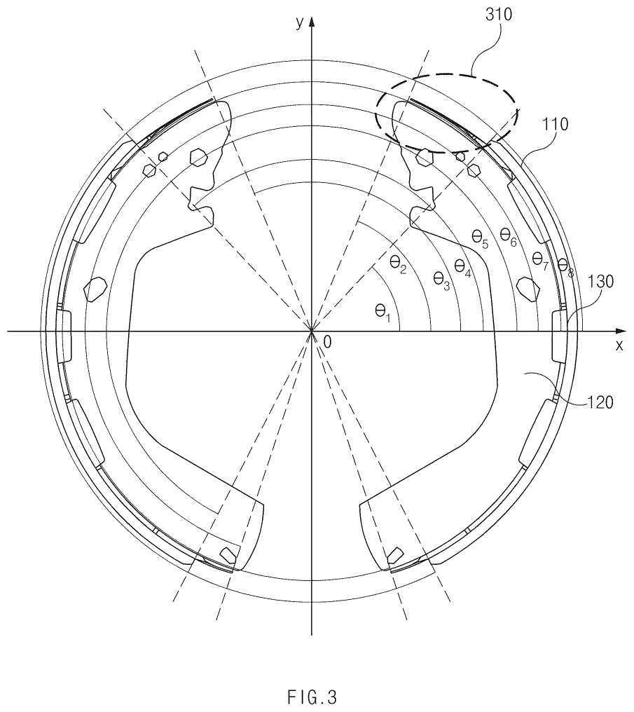

FIG. 3 is a view for describing a position in which a brake noise preventing member is mounted in the drum brake according to an embodiment of the present disclosure.

FIG. 3 illustrates a position 310 on which the brake noise preventing member 210 is mounted in the drum brake 100. For example, at an upper left end of the brake shoe, the brake noise preventing member 210 may be positioned inside an area of θ₃ (e.g., an angular position of an upper distal end of the rim 130) and θ₄ (e.g., an angular position of an upper distal end of the lining 110). At a lower left end of the brake shoe, the brake noise preventing member 210 may be positioned within areas of θ₅ (e.g., an angular position of a lower distal end of the lining 110) and θ₆ (e.g., an angular position of a lower distal end of the rim 130). At an upper right end of the brake shoe, the brake noise preventing member 210 may be positioned inside areas of θ₁ (e.g., an angular position of an upper distal end of the lining 110) and θ₂ (e.g., an angular position of an upper distal end of the rim 130). At a lower right end of the brake shoe, the brake noise preventing member 210 may be positioned insides areas of θ₇ (e.g., an angular position of a lower distal end of the rim 130) and θ8 (e.g., an angular position of a lower distal end of the lining 11). The position 310 on which the brake noise preventing member 210 is mounted may include the one side or the other side of the rim 130, which is machined into the curved surface corresponding to the predetermined function.

FIG. 4 is a view for describing a curved surface included in a rim in the drum brake according to an embodiment of the present disclosure.

The rim 130 may be machined into a curved surface corresponding to at least one of a first curved line corresponding to the predetermined function, a second curved line different from the first curved line, or a linear line, or any combination thereof. In detail, the first curved line may be determined based on a first function for suppressing reflected waves in the drum brake 100. The second curved line may be determined based on a second function for cooling the drum brake 100.

An effect of suppressing reflected waves according to a curved line included in the rim 130 of the drum brake 100 may be described by Equation 1 and Equation 2 below.

$$k = {( \frac{3 {df}^{2}}{{Em}^{2}} )}^{1 / 4} \cdot \frac{1}{{x}^{n / 2}} \qquad Equation 1$$

Here, mxⁿ may mean a shape or profile of a beam (e.g., the rim 130) according to a power function, “d” may mean a density of the beam, “E” may mean the Young's modulus of the rim 130, “f” may mean an angular frequency of bending waves, and “k” may mean a wave number of beam bending waves of the machined surface of the power function.

$$T = \frac{1}{2 {m}^{1 / 2}} {( \frac{3 d}{{Ef}^{2}} )}^{1 / 4} \cdot {\int }_{{x}_{1}}^{{x}_{2}} {x}^{- n / 2} dx \qquad Equation 2$$

Here, x₁, x₂ may mean predetermined two points inside the beam according to the power function, and “T” may mean a time consumed for wave propagation of the machined surface according to the power function. In other words, Equation 2 may include the meaning that a travel time of the waves increases as a speed of the waves decreases under the same travel distance, and a wave delay phenomenon of the waves may be described through Equation 2.

A cooling process of the drum brake 100 may include heat transfer forms such as conduction, convection, and radiation. The cooling process due to the convection may include a phenomenon in which a surface of the brake shoe is moved and cooled due to a temperature difference with an outdoor air and may be expressed by Equation 3 below.

$${q}_{c} = h A Δ T \qquad Equation 3$$

Here, q_{c} may mean a cooling heat transfer rate due to convection, “h” may mean a coefficient of cooling convection, “A” may mean a convection area, and ΔT may mean a temperature difference between the outdoor air and a surface of the shoe.

The cooling process due to the radiation may include a phenomenon in which atoms on the surface of the brake shoe are excited by heat and cooled while radiating electromagnetic waves to the outdoor air and may be expressed by Equation 4 below.

$${q}_{r} = εσ {AT}_{s}^{4} \qquad Equation 4$$

Here, qᵣ may mean a cooling heat transfer rate due to radiation, ε may mean a radiation emissivity, σ may mean the Stefan-Boltzmann constant, and Tₛ may mean a temperature of the surface of the shoe.

To suppress reflected waves in the drum brake 100, a curved line 410 included in the rim 130 may be determined based on a power function. In detail, the power function may be used to determine the first curved line. For example, the power function may be expressed by Equation 5 below.

$$y = {mx}^{n} ( n \geq 2 ) \qquad Equation 5$$

Here, (x, y) may be included in the graph illustrated in FIG. 4, and (m, n) may mean a coefficient for deriving the power function.

Illustratively, a target point (e.g., (a, b)) may represent a point included in the curved line 410. The target point may be expressed as a position (a, b) in the graph illustrated in FIG. 4. Applying the target point to a graph illustrated in FIG. 4 may be expressed by Equation 6 below.

$$b = {ma}^{n} \qquad Equation 6$$

Here, the target point may mean a state of being applied to the power function expressed in Equation 6.

The first curved line may be determined as a curved line that may be expressed by the power function. In detail, when the power function expressed in Equation 6 is a quadratic function (e.g., when n is 2), the drum brake 100 may have excellent suppression of the reflected waves and/or low-frequency waves. Further, in terms of cooling of the drum brake 100, as a surface area increases, thermal convection and radiation may be predominant. In other words, the first curved line may be determined by a first function for suppressing reflected waves and/or low-frequency waves from the drum brake 100 and a second function for cooling the drum brake 100. The first function may be expressed by Equation 7 below, and the second function may be expressed by Equation 8 below.

$${L}_{1} = {\int }_{0}^{a} \sqrt{1 + {( 2 {m}_{2} x )}^{2}} d x \qquad Equation 7$$

Here, L₁ may mean a length of the curved line calculated by the first function, and

$${\int }_{0}^{a} \sqrt{1 + {( 2 {m}_{2} x )}^{2}} dx$$

$${L}_{2} = a + b \qquad Equation 8$$

Here, L₂ may mean a length of the curved line calculated by the second function, and a+b may mean a length of the curved line of the second function. For reference, in the specification, for convenience of description, a+b is described as the length of the curved line, but the present disclosure is not limited thereto. For example, L₂ or a+b may mean a vertical machining length for maximize cooling performance of the drum brake 100.

$${L}_{n} = {sL}_{1} + {tL}_{2} = {\int }_{0}^{a} \sqrt{1 + {( {mnx}^{n - 1} )}^{2}} dx \qquad Equation 9$$

Here, Lₙ may mean the length of the first curved line, and sL₁+tL₂ may mean the first weight (e.g., a noise decrease weight) applied to Equation 7 and the second weight (e.g., a cooling weight) applied to Equation 8. In detail, the first weight may refer to a noise decreasing weight and may mean a weight that may decrease noise of the drum brake 100. The second weight may refer to a cooling weight and may mean a weight that may increase the cooling effect of the drum brake 100. Each of the first weight and the second weight may satisfy a predetermined section (e.g., a section of 0 or more and 1 or less). Further, a result obtained by adding the first weight and the second weight may satisfy a predetermined value (e.g., one), but the present disclosure is not limited thereto.

A vehicle equipped with the rim 130 having a machined surface illustrated in FIG. 4 may perform the braking due to contact between the lining 110 and the drum due to forward movement of the brake shoe through a brake hydraulic pressure when the driver steps on the brake pedal. In this case, due to the friction between the lining 110 and the drum, waves may be generated in a circumferential direction, and an excitation source of braking noise may be generated. That is, waves (e.g., solid waves) due to friction excitation may be propagated in both circumferential directions of the brake shoe. As the waves pass through the brake noise preventing member 210 mounted on the rim 130, a wave number and amplitude thereof may increase, and a propagation speed thereof may decrease.

The braking friction noise may be generated as waves are propagated in a circumferential direction of the brake shoe due to the friction between the lining 110 and the drum and the propagated waves serve as an excitation source. Here, the drum brake 100 may delay and dissipate the propagation of waves that may be generated by applying the reflected wave suppressing member to the distal end of the rim 130 in the brake shoe. The drum brake 100 may finally decrease the braking friction noise through a decrease in the excitation force of the excitation source. The waves may be dissipated due to the viscoelastic layer attached to the power function machined surface. That is, the magnitude of vibration at the excitation source may be decreased overall in the brake shoe. Therefore, as the excitation source is decreased, friction noise in the drum, which is a cause of final noise, may be decreased.

An effect of a drum brake according to the present disclosure will be described as follows.

According to at least one of embodiments of the present disclosure, development costs of the drum brake due to frequency avoidance between components included in the drum brake and addition of a damping member for an amplitude decrease to the drum brake may decrease.

Further, according to at least one of embodiments of the present disclosure, a drum brake including a rim machined into a curved line based on a first function for suppressing reflected waves of a brake and a second function for cooling the brake may be provided, thereby suppressing squeal noise and the reflected waves of the brake.

In addition, various effects directly or indirectly identified though the present document may be provided.

As described above, although embodiments have been described with limited drawings, those skilled in the art may apply various technical modifications and variations based on this. For example, even though the described technologies are performed in an order different from the described method, and/or the described components such as a system, a structure, a device, and a circuit are coupled or combined in a form different from the described method or are replaced or substituted by other components or equivalents, appropriate results may be achieved.

Therefore, other implementations, other embodiments, and equivalents to the claims also fall within the scope of the claims described below.

Thus, embodiments disclosed in the present disclosure are not intended to limit the technology spirit of the present disclosure but are intended to describe the present disclosure, and the scope of the technical spirit of the present disclosure is not limited by these embodiments. The scope of protection of the present disclosure should be interpreted by the appended claims, and all technical spirits within the scope equivalent thereto should be interpreted as being included in the scope of the present disclosure.

The invention claimed is:

1. A drum brake comprising:
a brake shoe positioned inside a drum and operating toward the drum by a pressing member configured to operate a piston in one direction;
a lining coupled to the brake shoe configured to apply a braking force to the drum;
a rim to which the lining is attached and of which a first side is machined into a curved surface corresponding to a predetermined function; and
a brake noise preventing member coupled to the first side of the rim and configured to decrease squeal noise generated at a time point at which the braking force is generated by the lining and the drum.

2. The drum brake of claim 1, wherein the brake noise preventing member includes at least one of a viscoelastic layer made of rubber, or a viscoelastic layer made of polyurethane, or any combination thereof.

3. The drum brake of claim 2, wherein the viscoelastic layer made of rubber includes a layer including an adhesive, rubber, and metal.

4. The drum brake of claim 2, wherein the viscoelastic layer made of polyurethane includes a layer including an adhesive, polyurethane, and nanoclay.

5. The drum brake of claim 1, wherein the rim is machined into a curved surface corresponding to at least one of a first curved line corresponding to the predetermined function, a second curved line different from the first curved line, or a linear line, or any combination thereof.

6. The drum brake of claim 5, wherein the first curved line is determined based on a first function for suppressing reflected waves in the drum brake.

7. The drum brake of claim 5, wherein the second curved line is determined based on a second function for cooling the drum brake.

8. The drum brake of claim 1, wherein the rim includes:
a first surface attached to the lining; and
a second surface opposite to the first surface and facing a web connected to the pressing member;
wherein at least a partial area of the second surface is spaced apart from the web.

9. The drum brake of claim 1, wherein a second side of the rim, which is different from a first side of the rim, is machined into a curved surface corresponding to the predetermined function.
